(19) United States
(12) Patent Application Publication
(10) Pub. No.: US 2021/0196551 A1
(43) Pub. Date: Jul. 1, 2021

(54) Leg Support Apparatus

(71) Applicant: James Burke, New Braunfels, TX (US)

(72) Inventor: James Burke, New Braunfels, TX (US)

(21) Appl. No.: 16/729,972

(22) Filed: Dec. 30, 2019

(51) Int. Cl. A61G 13/12

(52) U.S. Cl. CPC A61G 13/1245

(57) ABSTRACT

A leg support apparatus for elevating and exercising an injured leg includes a base. A pair of vertical support legs is coupled to the base. Each support leg has an articulation bracket positioned on a top end thereof. A pair of thigh rods is pivotably coupled to the articulation bracket of the pair of support legs. A gluteal bar and a plurality of thigh straps extend between the thigh rods. A pair of calf rods is pivotably coupled to the articulation bracket. A foot bar extends between a front distal end of each of the foot rods. A plurality of calf straps extends between the calf rods. A pair of pistons is coupled to the pair of support legs and extends to the pair of calf rods to support the pair of calf rods in a horizontal position.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to medical devices and more particularly pertains to a new medical device for elevating and exercising an injured leg.

### (2) Description of Related Art Including Information Disclosed Under 37 CFR 1.97 and 1.98

The prior art relates to medical devices. Existing devices to elevate and support an injured leg or foot typically provide support at only one point, whether it be the heel/foot, the calf, the knee, or the thigh. Such devices may be uncomfortable to the user and most do not allow for articulation of the knee. Most existing devices provide fixed support with the only available adjustment being for height. Of those devices that do provide for multi-point support and also allow articulation, none allow for adjustable support strength that allow the user to both simultaneously receive full support from gravitational support but also allow the user to perform resistance-based rehabilitation exercises as desired.

### BRIEF SUMMARY OF THE INVENTION

An embodiment of the disclosure meets the needs presented above by generally comprising a base. A pair of vertical support legs is coupled to the base. Each support leg has an articulation bracket positioned on a top end thereof. A pair of thigh rods is coupled to the pair of support legs. Each thigh rod is pivotably coupled to the articulation bracket. A gluteal bar extends between a rear distal end of each of the thigh rods. A plurality of thigh straps extends between the thigh rods. A pair of calf rods is pivotably coupled to the articulation bracket. A foot bar extends between a front distal end of each of the foot rods. A plurality of calf straps extends between the calf rods. A pair of pistons is coupled to the pair of support legs and extends to the pair of calf rods to support the pair of calf rods in a horizontal position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a side elevation view of a leg support apparatus according to an embodiment of the disclosure.

FIG. 2 is a front elevation view of an embodiment of the disclosure.

FIG. 3 is a rear elevation view of an embodiment of the disclosure.

FIG. 4 is a top plan view of an embodiment of the disclosure.

FIG. 5 is a bottom plan view of an embodiment of the disclosure.

FIG. 6 is an in-use view of an embodiment of the disclosure.

### DETAILED DESCRIPTION OF THE INVENTION

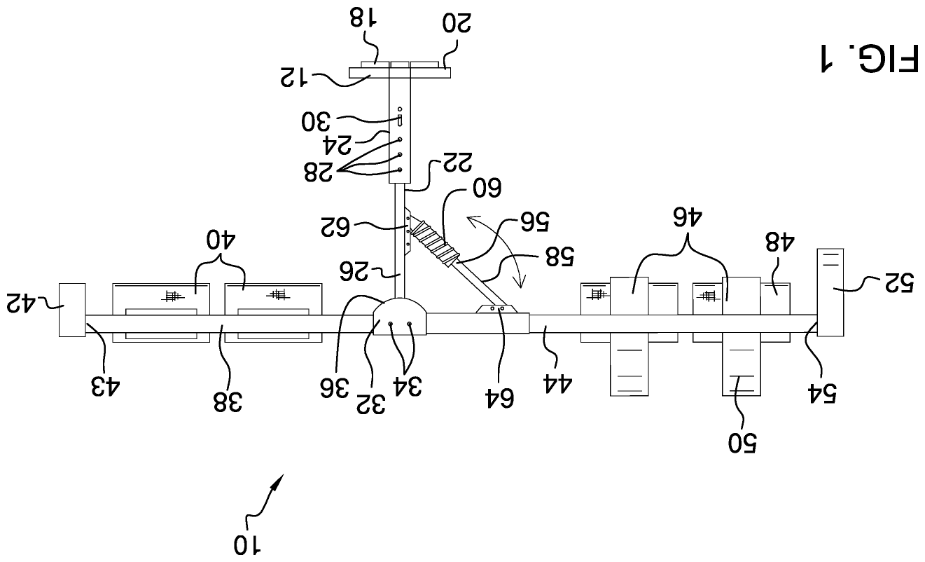

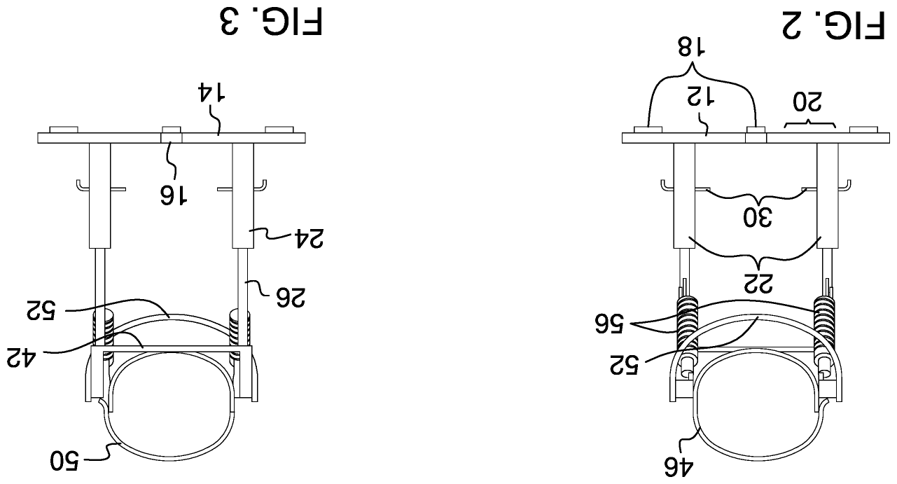

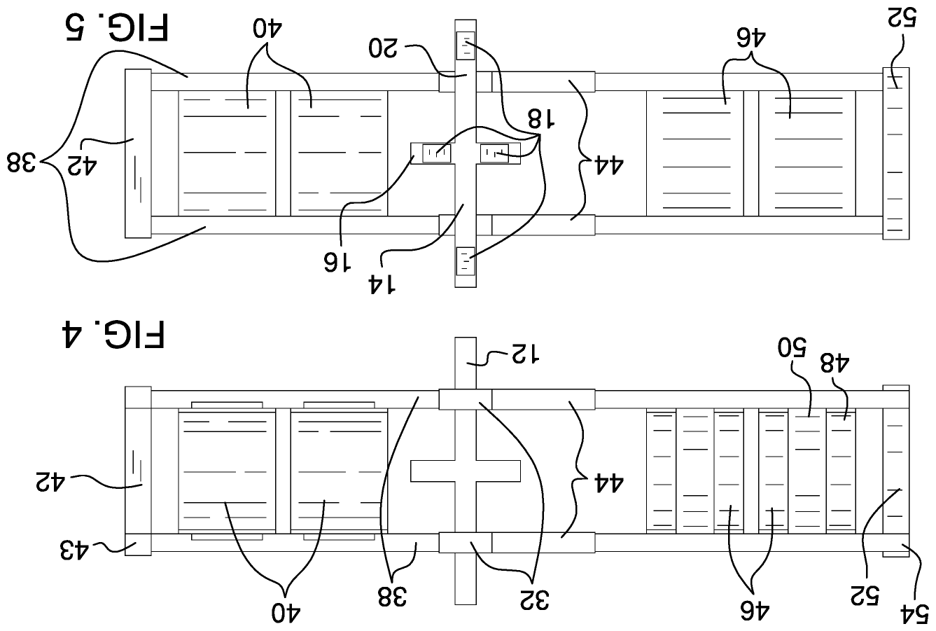

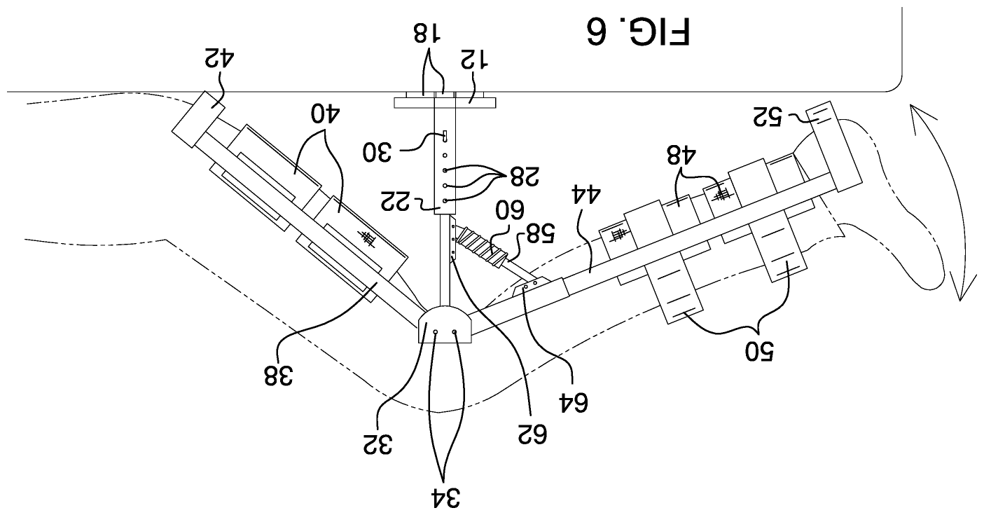

With reference now to the drawings, and in particular to FIGS. 1 through 6 thereof, a new medical device embodying the principles and concepts of an embodiment of the disclosure and generally designated by the reference numeral 10 will be described.

As best illustrated in FIGS. 1 through 6, the leg support apparatus 10 generally comprises a base 12. The base 12 may be cross-shaped and includes a first portion 14 and a second portion 16 perpendicular to the first portion 14. The first portion 14 may be at least twice the length of the second portion 16. A plurality of non-skid pads 18 may be coupled to an underside 20 of the base to steady the apparatus 10. A pair of vertical support legs 22 is coupled to the base 12. Each support leg 22 includes a lower portion 24 coupled to the first portion 14 of the base and an upper portion 26 slidably coupled within the lower portion 24. The lower portion 24 may have a plurality of lower through holes 28 and the upper portion 26 may have an upper through hole. Each support leg 22 has an adjustment pin 30 selectively engaged through the lower through holes 28 and the upper through hole to secure the support leg 22 at a desired height. Each support leg 22 may alternatively have a clamp, a spring-loaded button, or other tightening mechanism to fix the telescoping motion of the upper portion 26. Each support leg 22 has an articulation bracket 32 positioned on a top end 34 thereof. Each articulation bracket 32 may have a pair of pivot apertures 34 extending therethrough and a rounded bottom edge 36.

A pair of thigh rods 38 is coupled to the pair of support legs 22. Each thigh rod 38 is pivotably coupled to the articulation bracket 32 and oriented perpendicular to the first portion 14 of the base. A plurality of thigh straps 40 is coupled to the pair of thigh rods 38. The plurality of thigh straps 40 extend between the thigh rods 38 and is configured to conform and give support to the user's thigh. A gluteal bar 42 extends between a rear distal end 43 of each of the thigh rods. The gluteal bar 42 may be a squared U-shape and extends to a plane containing the lowest point of the thigh straps 40. The gluteal bar 42 is configured to give support to the user's buttocks and to rest on the surface upon which the user is lying.

A pair of calf rods 44 is pivotably coupled to the articulation bracket 32 oriented in the same planes as the pair of thigh rods 38. A plurality of calf straps 46 extend between the calf rods 44. Each calf strap 46 may comprise a lower calf support portion 48 configured to support the user's calf from below and a full looping strap portion 50 configured to secure the user's leg to the apparatus 10. As the user lifts his or her leg, the calf rods 44 pivot on the articulation bracket 32. A foot bar 52 extends between a front distal end 54 of each of the foot rods. The foot bar 52 may be a rounded U-shape and extends to a plane below the lowest point of the calf straps 46. The foot bar 52 may thus comfortably support the user's heel while the lower calf support portion 48 continue to support the user's calves. A pair of pistons 56 is coupled to the pair of support legs 22 and extends to the pair of calf rods 44 to support the pair of calf rods 44 in a horizontal position and resist movement when the calf rods 44 are pivoted out of the horizontal position. Each piston 56 may be a hydraulic cylinder 58 and may include a spring 60 to assist in returning the calf rods 44 to the horizontal position. Each support leg 22 may have a plurality of vertical attachment points 62 and each calf rod 44 may have a plurality of leg attachment points 64. The piston 56 is selectively engageable with each of the vertical attachment points 62 and each of the leg attachment points 64 to create adjustable support and resistance to the pair of calf rods 44.

In use, the base 12 is placed on the surface on which the user is lying with his heel resting on the foot bar 52 and his buttocks resting on the gluteal bar 42 with his knee aligned with the articulation brackets 32. Each thigh rod 38 and each calf rod 44 may be telescopably adjustable to achieve said alignment. The support legs 22 are adjusted to achieve a comfortable angle of the thigh rods 38 to support the user's thigh between the buttocks and the knee. The strap portion 50 is secured around the user's leg and may include a hook-and-loop fastener or other engagement member such as, but not limited to, snaps, buckles, and the like. The pistons 56 are engaged with the appropriate vertical attachment point 62 and leg attachment point 64 to provide sufficient resistance to support the calf rods 44 in the horizontal position under the weight of the user's leg. The user may intentionally move against the resistance of the pistons 56 for rehabilitation exercise.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A leg support apparatus comprising:
a base;
a pair of vertical support legs coupled to the base, each support leg having an articulation bracket positioned on a top end thereof;
a pair of thigh rods coupled to the pair of support legs, each thigh rod being pivotably coupled to the articulation bracket;
a gluteal bar coupled to the pair of thigh rods, the gluteal bar extending between a rear distal end of each of the thigh rods;
a plurality of thigh straps coupled to the pair of thigh rods, the plurality of thigh straps extending between the thigh rods;
a pair of calf rods coupled to the pair support legs, the pair of calf rods being pivotably coupled to the articulation bracket;
a foot bar coupled to the pair of calf rods, the foot bar extending between a front distal end of each of the foot rods;
a plurality of calf straps coupled to the pair of calf rods, the plurality of calf straps extending between the calf rods; and
a pair of pistons coupled to the pair of support legs, the pair of pistons extending to the pair of calf rods to support the pair of calf rods in a horizontal position.

2. The leg support apparatus of claim 1 further comprising each support leg being telescopably adjustable.

3. The leg support apparatus of claim 2 further comprising each support leg including a lower portion coupled to the base and an upper portion slidably coupled within the lower portion, the lower portion having a plurality of lower through holes and the upper portion having an upper through hole, each support leg having an adjustment pin selectively engageable through the lower through holes and the upper through hole to secure the support leg at a desired height.

4. The leg support apparatus of claim 1 further comprising the base being cross-shaped.

5. The leg support apparatus of claim 4 further comprising the base including a first portion extending perpendicularly to the thigh rods and a second portion extending parallel to the thigh rods, the pair of support legs being coupled to the first portion.

6. The leg support apparatus of claim 1 further comprising the gluteal bar being a squared U-shape and extending to a plane containing the lowest point of the thigh straps; the foot bar being a rounded U-shape and extending to a plane below the lowest point of the calf straps.

7. The leg support apparatus of claim 1 further comprising each support leg having a plurality of vertical attachment points and each calf rod having a plurality of leg attachment points, the piston being selectively engageable with each of the vertical attachment points and each of the leg attachment points to create adjustable support.

8. The leg support apparatus of claim 1 further comprising a plurality of non-skid pads coupled to an underside of the base.

9. The leg support apparatus of claim 1 further comprising each calf strap including a lower calf support portion and a full looping strap portion.

10. A leg support apparatus comprising:
a base, the base being cross-shaped and including a first portion and a second portion perpendicular to the first portion, a plurality of non-skid pads being coupled to an underside of the base;
a pair of vertical support legs coupled to the base, each support leg including a lower portion coupled to the first portion of the base and an upper portion slidably coupled within the lower portion, the lower portion having a plurality of lower through holes and the upper portion having an upper through hole, each support leg having an adjustment pin selectively engageable through the lower through holes and the upper through hole to secure the support leg at a desired height, each support leg having an articulation bracket positioned on a top end thereof;
a pair of thigh rods coupled to the pair of support legs, each thigh rod being pivotably coupled to the articulation bracket and oriented perpendicular to the first portion of the base;
a plurality of thigh straps coupled to the pair of thigh rods, the plurality of thigh straps extending between the thigh rods;
a gluteal bar coupled to the pair of thigh rods, the gluteal bar extending between a rear distal end of each of the thigh rods, the gluteal bar being a squared U-shape and extending to a plane containing the lowest point of the thigh straps;
a pair of calf rods coupled to the pair support legs, the pair of calf rods being pivotably coupled to the articulation bracket;
a plurality of calf straps coupled to the pair of calf rods, the plurality of calf straps extending between the calf rods, each calf strap including a lower calf support portion and a full looping strap portion;
a foot bar coupled to the pair of calf rods, the foot bar extending between a front distal end of each of the foot rods the foot bar being a rounded U-shape and extending to a plane below the lowest point of the calf straps; and
a pair of pistons coupled to the pair of support legs, the pair of pistons extending to the pair of calf rods to support the pair of calf rods in a horizontal position, each support leg having a plurality of vertical attachment points and each calf rod having a plurality of leg attachment points, the piston being selectively engageable with each of the vertical attachment points and each of the leg attachment points to create adjustable support.
